(19) United States
(12) Patent Application Publication
(10) Pub. No.: US 2021/0064569 A1
(43) Pub. Date: Mar. 4, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Takuya YAMADA, Kanagawa (JP)

(73) Assignee: FUJI XEROX CO., LTD., Tokyo (JP)

(21) Appl. No.: 16/827,893

(22) Filed: Mar. 24, 2020

(30) Foreign Application Priority Data
Aug. 30, 2019 (JP) 2019-157856

(51) Int. Cl. G06F 16/11; G06F 16/178

(52) U.S. Cl. CPC G06F 16/116; G06F 16/1794; G06F 16/122

(57) ABSTRACT

An information processing apparatus includes a converter unit that, if a file is received in a second file format different from a first file format from another information processing apparatus, coverts the file to a file in the first file format and an adding unit that generates additional information including at least attribute information that is missing out of attribution information included in the file in the second file format if the file is converted by the converter unit and adds the additional information to the file after being converted to the first file format.

### CROSS-REFERENCE TO RELATED APPLICATIONS

This application is based on and claims priority under 35 USC 119 from Japanese Patent Application No. 2019-157856 filed Aug. 30, 2019.

### BACKGROUND

### (i) Technical Field

The present disclosure relates to an information processing apparatus and a non-transitory computer readable medium.

### (ii) Related Art

Software as a Service (SaaS) has been in widespread use. Saas is a multi-tenant structure where multiple tenant users are present in a common system environment that supports Platform as a Service (PaaS) in the form of information service. Applying SaaS service to a document management system (DMS) managing in-house documents is also contemplated.

From the standpoint of security, in a typical DMS, documents that include customer information or confidential information involving a higher security management level is managed at an in-house DMS and the rest of the documents and a document that is shared with another company is managed at SaaS DMS.

The file format of a file that is managed at an in-house DMS may be determined by accounting for convenience of business operation. The file format to be used may not necessarily match the file format used in the SaaS DMS. In such a case, the file format is converted to cause the file managed at the in-house DMS to be also managed at the SaaS DMS.

For related art techniques, reference is made to Japanese Unexamined Patent Application Publication Nos. 2002-123506 and 2010-079850 and Japanese Patent No. 4160544.

A variety of attribute information may be set in a file. All the types of attribute information included in the file are not necessarily standardized. Some of the attribute information depends on the file format. If the file format is converted, attribute information held in an original file may possibly be missing.

### SUMMARY

Aspects of non-limiting embodiments of the present disclosure relate to controlling missing of attribute information included in a file in an original file format when the file format of the file is converted.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. The information processing apparatus includes a converter unit that, if a file in a second file format different from a first file format is received from another information processing apparatus, coverts the file to a file in the first file format and an adding unit that generates additional information including at least attribute information that is missing with the file converted by the converter unit out of attribution information included in the file in the second file format and adds the additional information to the file after being converted to the first file format.

### BRIEF DESCRIPTION OF THE DRAWINGS

Exemplary embodiment of the present disclosure will be described in detail based on the following figures, wherein:

FIG. 1 is a block diagram illustrating a business cooperative system of the exemplary embodiment;

FIG. 2 illustrates the relationship of a file format, file property, and attribute information on a document in accordance with the exemplary embodiment;

FIG. 3 illustrates a display example of a registration screen used when a document is registered at a joint DMS in accordance with the exemplary embodiment;

FIG. 4 is a flowchart illustrating a document registration process in accordance with the exemplary embodiment;

FIG. 5 illustrates the relationship of file properties before and after the conversion of a registration document in accordance with the exemplary embodiment;

FIG. 6 is a flowchart illustrating a document retrieval process in accordance with the exemplary embodiment;

FIG. 7 illustrates a display example of a retrieval screen used when a document is retrieved from the joint DMS in accordance with the exemplary embodiment;

FIG. 8 illustrates the relationship of file properties before and after the conversion of a retrieved document in accordance with the exemplary embodiment;

FIG. 9 illustrates a display example on a display screen that displays a file property of a document retrieved from the joint DMS;

FIG. 10 illustrates a display example on an update screen used when a document registered on the joint DMS is updated in accordance with the exemplary embodiment;

FIG. 11 illustrates the relationship of attribute information before and after the conversion of an update document in accordance with the exemplary embodiment;

FIG. 12 illustrates the relationship of file properties before and after the retrieved document in accordance with the exemplary embodiment; and

FIG. 13 illustrates a display example on a display screen that displays the file property of a document retrieved from the joint DMS in accordance with the exemplary embodiment.

### DETAILED DESCRIPTION

Exemplary embodiment of the disclosure is described with reference to the drawings.

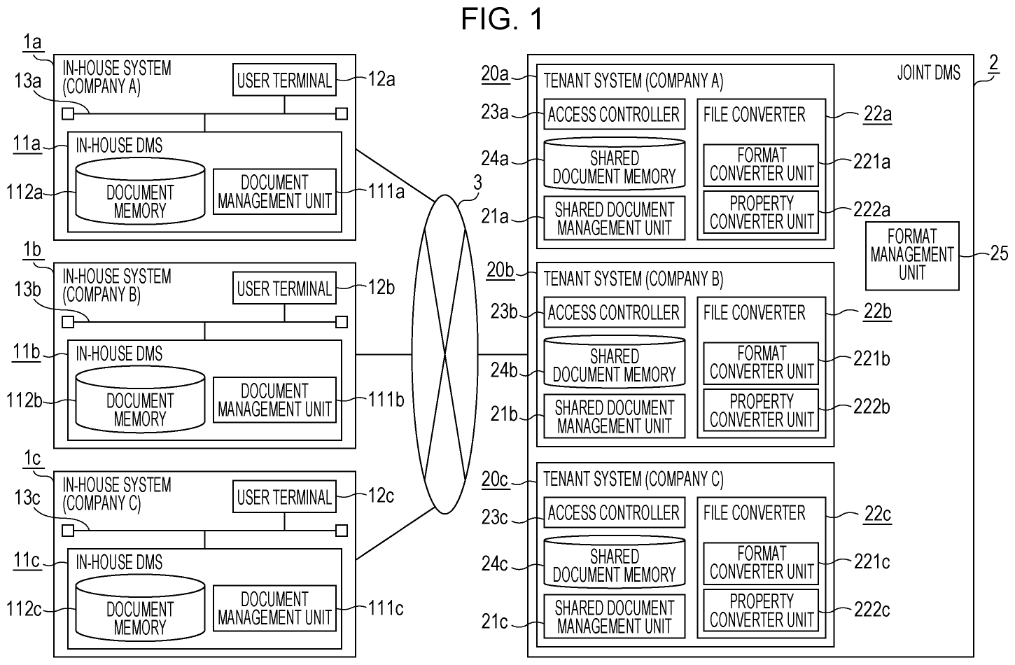

FIG. 1 is a block diagram illustrating a business cooperative system of the exemplary embodiment. Referring to FIG. 1, in-house systems 1a, 1b, and 1c are owned by respective companies that operate business in cooperation with each other. A joint DMS 2 is used by multiple tenant systems 20a, 20b, and 20c. In accordance with the exemplary embodiment, a company that uses the joint DMS 2 is also referred to as a “tenant”. In accordance with the exemplary embodiment, the joint DMS 2 is used by three companies A, B, and C. The number of companies that use the joint DMS 2 is plural and is not limited to three.

Referring to FIG. 1, the in-house systems 1a, 1b, and 1c in respective companies are identical in configuration to each other and the tenant systems 20a, 20b, and 20c in respective companies are also identical in configuration to each other. If the elements are not differentiated from each other in the following discussion, suffixes “a”, “b”, and “c” are not used. For example, the in-house systems 1a, 1b, and 1c are collectively referred to as the “in-house system 1”.

A “document management system” (hereinafter referred to as “DMS”) is a system on a computer that stores and manages digital documents. Each company uses together an in-house DMS 11 in an in-house system 1 and the joint DMS 2. In accordance with the exemplary embodiment, a document that is at a higher security level and is desirably segregated from other companies may be managed at the in-house DMS 11 and a document that is intended to be shared with another company for business collaboration or a document having a low to medium security level may be managed at the joint DMS 2. Whether to manage each document at the in-house DMS 11 or the joint DMS 2 may be appropriately determined in accordance with a contract signed between the related companies. The document handled in accordance with the exemplary embodiment is stored and managed at the in-house DMS 11 or the joint DMS 2. If the in-house DMS 11 is not differentiated from the joint DMS 2, they are simply referred to as “DMS”.

The in-house system 1 includes the in-house DMS 11 and user terminals 12 connected to each other via a network 13, such as local-area network (LAN). The in-house system 1 may be connected to the joint DMS 2 via the Internet 3.

The user terminal 12 is an information processing apparatus that is used when a process related to a document managed by the DMS is performed. The user terminal 12 is implemented by a general-purpose computer (PC) and includes a central processing unit (CPU), read-only memory (ROM), random-access memory (RAM) and hard disk drive (HDD), each serving as a memory, user interface, network interface serving as a communication medium, and internal bus interconnecting these elements. The user interface includes an input unit, such as a mouse and keyboard, and a display. The network 13 may connect to multiple user terminals 12. An application accessing the DMS and an application displaying a web page are installed on the user terminal 12.

The in-house DMS 11 is a document management system managing a document used within an in-house environment and is implemented by a general-purpose server computer. The in-house DMS 11 includes a CPU, ROM, RAM and HDD, each serving as a memory, network interface serving as a communication medium, and internal bus interconnecting these elements. The in-house DMS 11 includes a document memory 112 that stores a document as a management target and a document management unit 111 that manages the document stored on the document memory 112. In response to a request from a user, the document management unit 111 not only manages a document stored on the document memory 112 but also registers or retrieves a document registered on the joint DMS 2 in cooperation with a shared document management unit 21 in a tenant system 20. The document management unit 111 is implemented when a computer forming the in-house DMS 11 operates in cooperation with a program running on the CPU in the computer. The document memory 112 is implemented by an HDD installed in the in-house DMS 11. Alternatively, a RAM may be used or an external memory may be used via a network.

The joint DMS 2 manages a document shared by multiple companies. The joint DMS 2 is arranged external to the in-house system 1 and may be implemented by using cloud computing. The joint DMS 2 is thus constructed by one or more server computers. The server computer is implemented by a general-purpose computer as the in-house system 1 is.

The joint DMS 2 includes a tenant system 20 arranged in each company and a format management unit 25. Each tenant system 20 and the format management unit 25 are connected to each other via a network (not illustrated) for accessing.

The tenant system 20 includes a shared document management unit 21, file converter 22, access controller 23, and shared document memory 24. The tenant system 20 may access the in-house system 1 via the Internet 3. Elements not discussed in the exemplary embodiment are not illustrated in the drawings.

A document shared with another company is stored on the shared document memory 24 in a file format used in the joint DMS 2. The shared document management unit 21 manages the document stored on the shared document memory 24. Specifically, the shared document management unit 21 performs control to register a document on the shared document memory 24 in response to a registration request from the in-house system 1 and delivers to the in-house system 1 a document stored on the shared document memory 24. In response to an instruction from the shared document management unit 21, the file converter 22 converts the file format and the property of a document exchanged between the in-house system 1 and the joint DMS 2. A format converter unit 221 in the file converter 22 converts the format of a document file and a property converter unit 222 in the file converter 22 converts the property of the document. The property is described below.

The access controller 23 controls access to a document stored on the shared document memory 24 in the tenant system 20 of another company. The document on the joint DMS 2 is stored in a distributed manner on the shared document memories 24 of the companies. With the access controller 23, the tenant system 20 may access each document regardless of the storage location thereof.

The format management unit 25 manages the format of the document file used in each company. The format management unit 25 also determines the format of the document file when the joint DMS 2 manages the document file.

The shared document management unit 21, the file converter 22, the access controller 23 and the format management unit 25 in the joint DMS 2 are implemented when the computer forming the joint DMS 2 operates in cooperation with the program running on the CPU in the computer. The shared document memory 24 is implemented by an HDD in the joint DMS 2.

The program used in the exemplary embodiment is provided by a communication medium. The program in the exemplary embodiment is also provided in a stored form on a computer readable recording medium, such as a compact disk read-only memory (CD-ROM) or universal serial bus (USB) memory. The program provided by the communication medium or recording medium is installed on the computer. Each process is thus performed when the CPU in the computer executes the program.

The format and property of the document file used in the exemplary embodiment are described below.

A document is stored in a file on the shared document memory 24 and the document memory 112. In the discussion of the exemplary embodiment, the term “document” and the term “document file” are interchangeable. The document may be stored in a variety of file formats. Typical file formats of document are portable document format (PDF) and WORD (trademark registered by Microsoft Corporation). In the in-house system 1, each company as a tenant determines the file format of a locally managed document by using the in-house DMS 11. The file format used in managing the document may be varied from company to company. In the exemplary embodiment, for convenience of explanation, the in-house DMS 11 of each company manages documents in a single file format. In the joint DMS 2 as well, documents are managed in a single file format. In the joint DMS 2, however, file format may be different from the in-house DMS 11 to the joint DMS 2 to manage documents of multiple companies.

Detailed information on a document different from the body of the document is set in the document file. In accordance with the exemplary embodiment, the detailed information on the document is referred to as a “file property” or simply “property”. The file property includes information items set in most of the file formats, such as time and date of creation of a file and creator. Some information items depend on a file format. In a document file that is created by a document application having a function of attaching a marker or tag, information on the marker and tag are included as attribute information in the document file. A storage location of the attribute information in the document file is typically a file header, but depends on the file format. In accordance with the exemplary embodiment, the file property included and stored in the document file is defined as the “attribute information”. A file property that may be the attribute information in the document of one file format may not be the attribute information in the document of another file format.

A document file created by a document application (such as Docuworks (trademark registered by Fuji Xerox Co., Ltd.) having a function of a marker (also called a highlighter), tag, or annotation includes a file property related to the marker or the like as the attribute information. On the other hand, a document file created by a document application (such as WORD) having a function of a marker but not having a function of tag is unable to include the file property related to the tag as the attribute information.

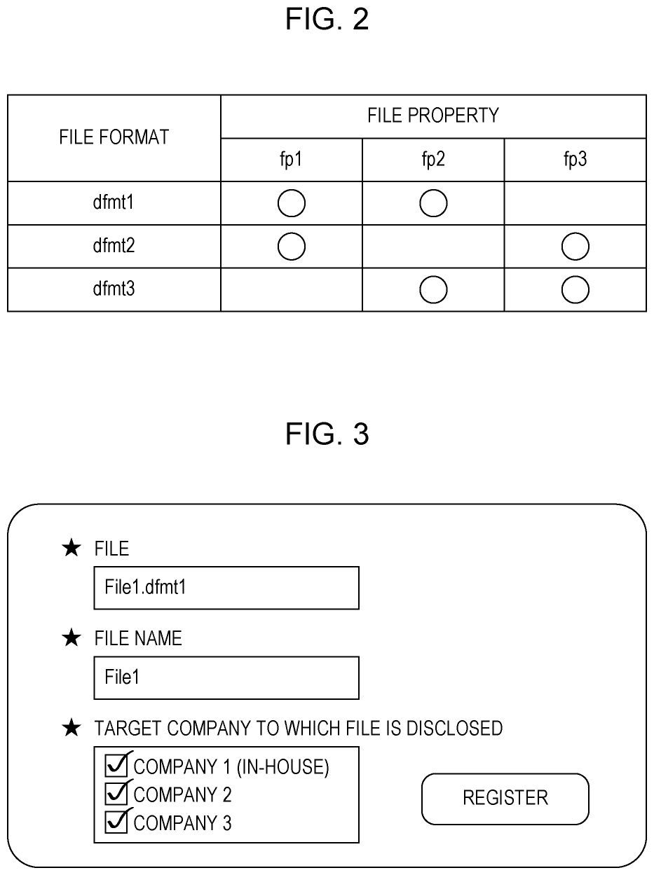

The relationship of the file format, the file property, and the attribute information on the document is specifically described with reference to FIG. 2.

Multiple file formats are used in the exemplary embodiment. Referring to FIG. 2, three types of file formats, dfmt1, dfmt2, and dfmt3 are used. Although there are many file properties, three types of properties fp1, fp2, and fp3 are described herein with reference to FIG. 2.

FIG. 2 illustrates that a document file in the file format dfmt1 may include properties fp1 and fp2 as the attribute information out of the properties fp1, fp2, and fp3. On the other hand, the document file in the file format dfmt1 is unable to include the property fp3 as the attribute information. If a document in the file format fmt1 is created by a document application not having the function of the marker, the file property related to the marker is not included as the attribute information.

A document file in the file format dfmt2 includes the properties fp1 and fp3 as the attribute information fp1 and fp3 but does not include the property fp2. The document file in the file format dfmt3 includes the properties fp2 and fp3 as the attribute information fp2 and fp3, but is unable to include the property fp1.

In accordance with the exemplary embodiment, an in-house DMS 11a in a company A manages each document in the file format dfmt1, an in-house DMS 11b in a company B manages each document in the file format dfmt2, and an in-house DMS 11c in a company C manages each document in the file format dfmt3. The joint DMS 2 manages each document in the file format dfmt3.

The in-house DMS 11 may now register the document managed by the in-house DMS 11a on the joint DMS 2. If the file format used in the in-house DMS 11a is different from the file format used in the joint DMS 2, file format conversion is performed to manage on the joint DMS 2 the document managed by the in-house DMS 11a.

If the file format conversion is performed, there is a possibility that the attribute information on the document before being converted may be missing in the document after being converted. Specifically, each document in the file format dfmt1 managed in the in-house DMS 11a has the attribute information fp1 and fp2 while a document in the file format dfmt3 managed in the joint DMS 2 has the attribute information fp2 and fp3. When documents are managed in the joint DMS 2, the attribute information fp1 included in the document in the file format dfmt1 may be missing in the file format conversion.

A process of the exemplary embodiment is described below. In the process, a user in the company A may now register a document on the joint DMS 2 by using a user terminal 12a.

FIG. 3 illustrates a display example of a registration screen used when a document is registered in the joint DMS 2. The user in the company A performs a predetermined operation on a browser to retrieve a page from the joint DMS 2 and causes the user terminal 12a to display the registration screen. The user then selects a document file as a registration target, a file name and a target company to which the document file as the registration target is to be disclosed. When the user selects a registration button, the user terminal 12a transmits to the in-house DMS 11a a registration request including an item specified to be input on the registration screen.

Upon receiving the registration request from the user terminal 12a, a document management unit 111a in the in-house DMS 11a retrieves a document file “File1.dfmt1” serving as a registration request target from the document memory 112a, adds the document file to the registration request, and then transmits the resulting registration request to the joint DMS 2.

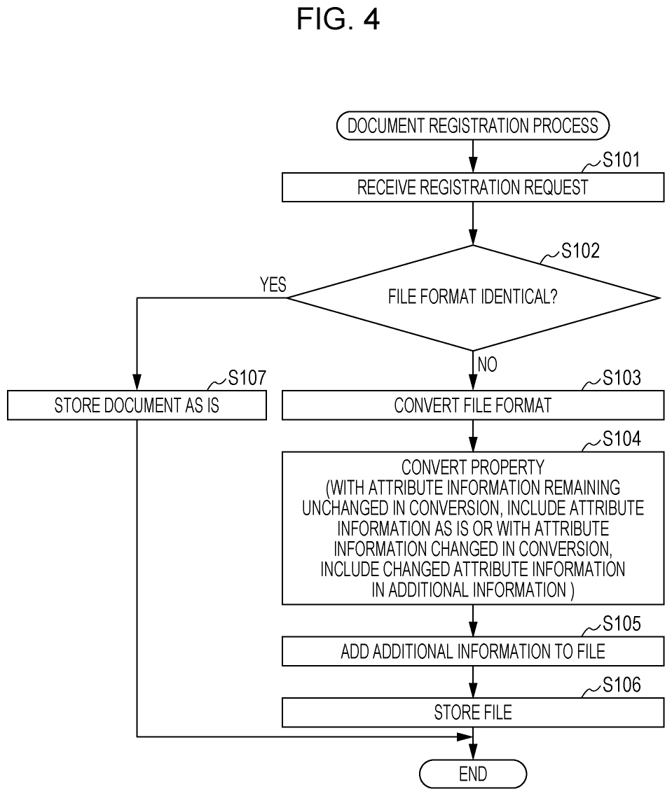

The registration process of the document performed by the joint DMS 2 is described with reference to the flowchart in FIG. 4.

The shared document management unit 21a in the tenant system 20a of the company A in the joint DMS 2 receives the registration request from the in-house system 1a (step 101) and verifies the file format of the document with the registration request attached thereto (step 102). The file format of the document “File1” is herein dfmt1 and is different from the file format dfmt3 used in the joint DMS 2 (no path from step 102). The shared document management unit 21a instructs the file converter 22a to convert the file format.

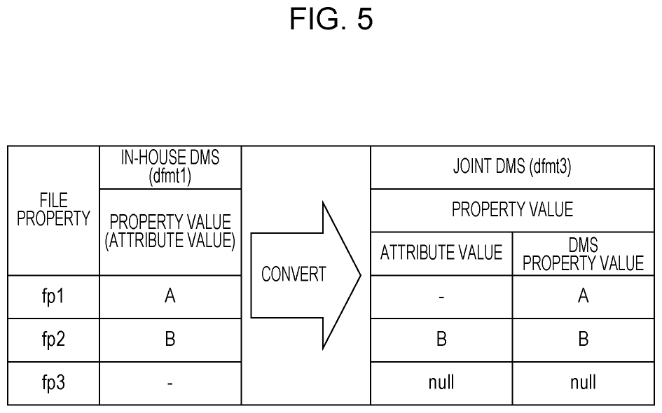

A format converter unit 221a in the file converter 22a converts the file format of the document “File1.dfmt1” from dfmt1 to dfmt 3 (step 103). A property converter unit 222a in the file converter 22a converts the attribute information on the document “File1.dfmt1” converts to the attribute information in the file format dfmt3 (step 104). The conversion process of the attribute information is described with reference to FIG. 5.

As previously described with reference to FIG. 2, the document file in the file format dfmt1 includes the attribute information fp1 and fp2. Referring to FIG. 5, attribute values of the attribute information fp1 and fp2 are respectively “A” and “B”. The file property fp3 does not match the attribute information on the document file in the file format dfmt1 and is unable to include the attribute information in the document file. The symbol “-” in FIG. 5 denotes that the document file is unable to include the attribute information.

The document file in the file format dfmt3 subsequent to the conversion may include file properties fp2 and fp3 as the attribute information but is unable to include the file property fp1. A property converter unit 222b includes, as the attribute information in the document file in the file format dfmt3 subsequent to the conversion, the attribute value “B” of the attribute information fp2 out of the attribute information fp1 and fp2 of the document in the file format dfmt1. On the other hand, the attribute value “A” of the attribute information fp1 is unable to be included as the attribute information on the document file in the file format dfmt3. Referring to FIG. 5, the symbol “-” indicates that the document file in the file format dfmt3 does not include the attribute value “A” of the attribute information fp1. The document file in the file format dfmt3 may include the attribute information on the file property fp3 but the document file in the file format dfmt1 prior to the conversion does not include the attribute information. In accordance with the exemplary embodiment, “null” indicating that there is no corresponding attribute information in the file format dfmt1 prior to the conversion is thus included as an attribute value of the attribute information fp3.

The attribute value “A” of the attribute information fp1 is thus missing without performing any operation in this way. The property converter unit 222a generates additional information including the attribute value “A” of the attribute information fp1 that is otherwise missing. In accordance with the exemplary embodiment, a property value to be included into the additional information is referred to as a “DMS property value”. In accordance with the exemplary embodiment, the attribute value of the attribute information missing in the file format conversion, in this case, the attribute value “A” of the attribute information fp1 is included in at least the DMS property value in the additional information. In accordance with the exemplary embodiment, the attribute value “B” of the attribute information fp2 not missing in the file format conversion is included together in the additional information. As with the attribute information, the property converter unit 222a includes in the additional information, as the property value of the file property fp3, “null” indicating that there is no corresponding attribute information prior to the file format conversion.

The shared document management unit 21a adds the additional information to the format-converted document “File1.dfmt3” (step 105) and stores the resulting document on a shared document memory 24a (step 106).

The in-house DMS 11c may now transmit a document registration request to the joint DMS 2. Since the in-house DMS 11c and the joint DMS 2 manage the documents in the same file format (yes path from step S102), the shared document management unit 21c stores a received document as is on the shared document memory 24c without causing the file converter 22c to convert the file format (step 107).

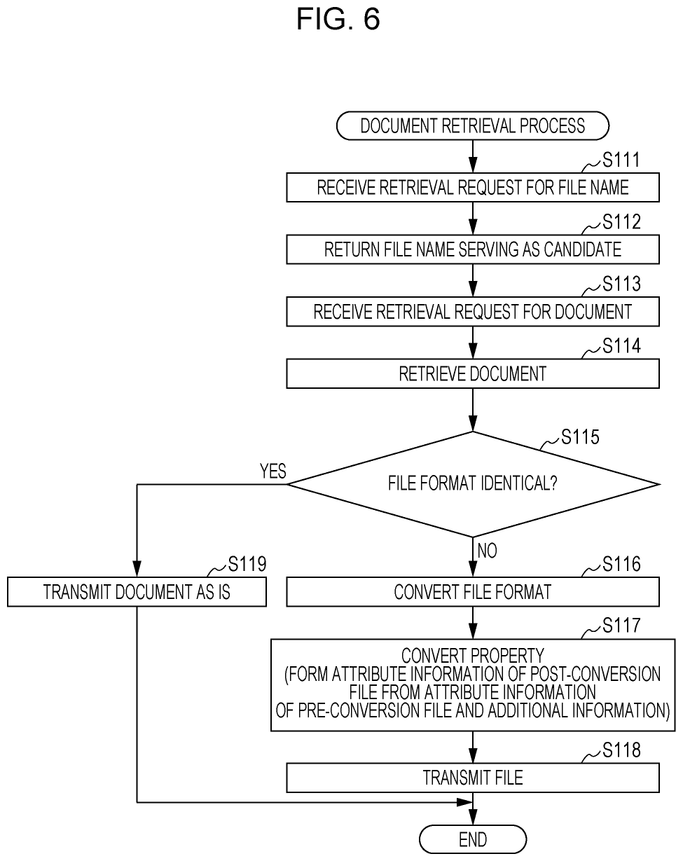

A document retrieval process is described with reference to the flowchart in FIG. 6. In the document retrieval process, a user in the company B retrieves a document registered on the joint DMS 2 by using the user terminal 12b.

The user in the company B transmits a document retrieval request to the in-house DMS 11b by performing a predetermined operation. The user may specify a retrieval condition for the document as a retrieval target. A document management unit 111b in the in-house DMS 11b transmits to the joint DMS 2 a retrieval request for a file name in response to the request from the user terminal 12b. The document management unit 111b may include, in the retrieval request as the retrieval condition for the file name, information on the user, such as a user identification (ID) and a group ID of the user. The document management unit 111b retrieves from the document memory 112b the file name of the document serving as a candidate for a retrieval target.

A shared document management unit 21b in the tenant system 20b of the company B in the joint DMS 2 receives the retrieval request for the file name transmitted from an in-house system 1b (step 111). The shared document management unit 21b retrieves the file name of the document serving as the candidate for the retrieval target stored on a shared document memory 24b. In response to an instruction from the shared document management unit 21b, an access controller 23b accesses other companies, in this case, the shared document memory 24a of the company A and the shared document memory 24c of the company C to retrieve the file names of the documents serving as candidates for the request targets. In response to the retrieval request from the document management unit 111b, the shared document management unit 21b and the access controller 23b retrieve the file name and the shared document management unit 21b returns the file name to the document management unit 111b (step 112).

The document management unit 111b in the in-house DMS 11b generates a retrieval screen including the file name retrieved in response to the retrieval request from the user terminal 12b and the file name transmitted from the joint DMS 2 in response to the retrieval request. The document management unit 111b then causes the user terminal 12b to display the retrieval screen.

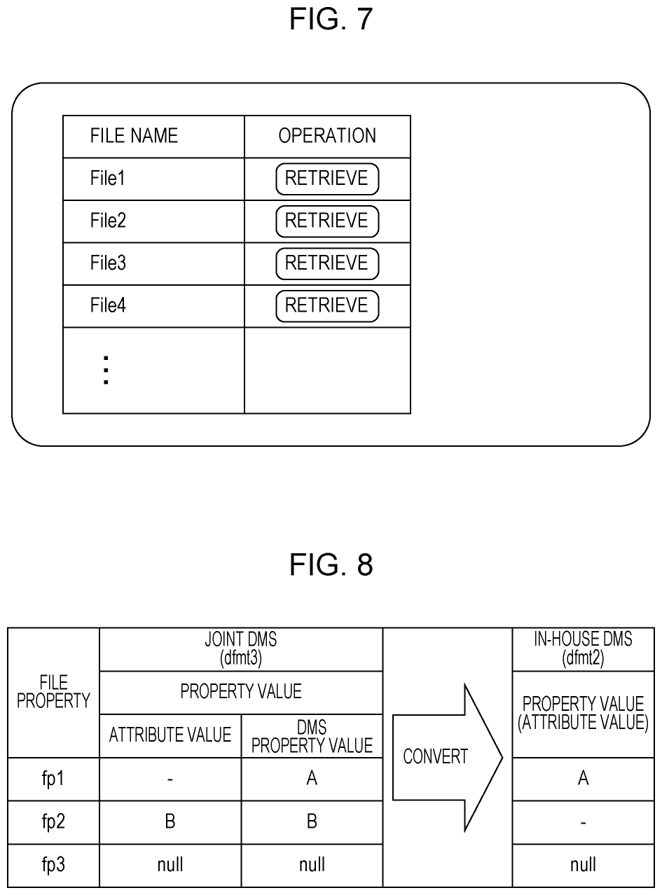

FIG. 7 illustrates a display example of the retrieval screen used when a document is retrieved. When the user selects on the retrieval screen a retrieval button responsive to a desired document, the in-house DMS 11b receives the document selected by the user. Specifically, if the selected document is locally stored, the document management unit 111b retrieves the document from the document memory 112b and delivers the document to the user. If the selected document is stored on the side of the joint DMS 2, the document management unit 111b retrieves the document in cooperation with the shared document management unit 21b and delivers the document to the user. The following discussion is based on the premise that the selected document is stored on the side of the joint DMS 2.

If the selected document is stored on the side of the joint DMS 2, the document management unit 111b transmits to the in-house DMS 11b the retrieval request for the document with the file name thereof specified.

The shared document management unit 21b in the tenant system 20b in the joint DMS 2 receives the document retrieval request from the in-house system 1b (step 113). The shared document management unit 21b retrieves the specified document from the shared document memory 24 (step 114). The user may now select the document “File1” managed in the tenant system 20a of the company A.

As previously described, the in-house DMS 11b of the company B manages the documents in the file format dfmt2 while the joint DMS 2 manages the documents in the file format dfmt3. If the file formats used in the in-house DMS 11 and the joint DMS 2 are different in this way (no path from step 115), a format converter unit 221b converts the file format of the document “File1.dfmt3” managed in the file format dfmt3 in the joint DMS 2 to the file format dfmt2 in response to an instruction from the shared document management unit 21b (step 116). The property converter unit 222b in a file converter 22b converts the attribute information on the document “File1.dfmt3” to the file format dfmt2 (step 117). The conversion process of the attribute information during the document retrieval is described with reference to FIG. 8.

The file property of the document “File1.dfmt3” (namely, the file property prior to the conversion in FIG. 8) is identical to the file property subsequent to the conversion in FIG. 5. As previously described with reference to FIG. 2, the document file in the file format dfmt3 includes the attribute information fp2 and fp3. The document file in the file format dfmt2 subsequent to the conversion includes the file properties fp1 and fp3. The property converter unit 222b thus includes, as the attribute information on the document file in the file format dfmt2 subsequent to the conversion, the attribute value “null” of the common attribute information fp3 out of the attribute information fp2 and fp3 of the document in the file format dfmt3. The attribute information fp2 of the document in the file format dfmt3 is unable to be included in the attribute information on the document in the file format dfmt2 subsequent to the conversion and this is denoted by the symbol “-”. The attribute information fp1 that the document in the file format dfmt2 may include is not included as the attribute information in the document in the file format dfmt3 but is stored as the DMS property value “A” in the additional information on the document “File1.dfmt3”. The property converter unit 222b thus references the additional information and includes the DMS property value “A” in the attribute information on the document “File1.dfmt2” in the file format dfmt2.

The shared document management unit 21b transmits thus converted document to the in-house DMS 11b as a retrieval requester (step 118).

The in-house DMS 11c may transmit a document retrieval request to the joint DMS 2. Since the in-house DMS 11c and the joint DMS 2 manage the documents in the same file format (yes path from step 115), the shared document management unit 21c transmits a specified document to the in-house DMS 11c as the retrieval requester without causing the file converter 22c performing the file format conversion (step 119).

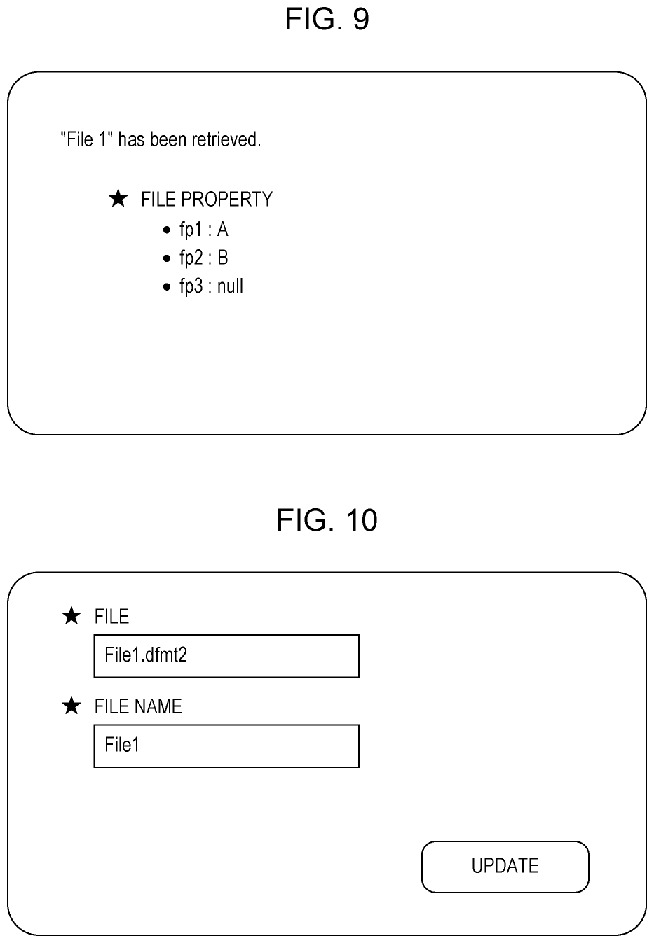

FIG. 9 illustrates a display example displayed on the screen of the user terminal 12b. The display example is the file property of the document having a file name “File1” and retrieved from the joint DMS 2 in accordance with the exemplary embodiment. As previously described, the documents are managed in the file format dfmt2 in the in-house system 1b. The file properties fp1 “A” and fp3 “null” are read from the attribute information on the document “File1.dfmt2” and displayed on the screen.

The file property fp2 does not include the attribute information on the document “File1.dfmt2”. The shared document management unit 21b transmits to the document management unit 111b the file property fp2 “B” included in the attribute information on the document “File1.dfmt3”. The shared document management unit 21b thus performs control to display the file property fp2 “B” as the property value of the file property fp2 together with the attribute information on the document “File1.dfmt2” as illustrated in FIG. 9. In accordance with the exemplary embodiment, the file property fp2 “B” is not included as the attribute information on the document “File1.dfmt2” but is included as the attribute information on the document “File1.dfmt1” at the registration and is included as the attribute information on the document “File1.dfmt3” at the storage. The file property fp2 “B” is thus displayed on the screen to the user. In the above discussion, the file property fp2 “B” that is present is displayed without any condition. In the joint DMS 2, however, display control information as to whether to display the file property fp2 “B” is set on each piece of the attribute information included in the document “File1.dfmt3” and the shared document management unit 21b may perform control to display the attribute information (in the above case “B”) in accordance with the display control information.

The in-house system 1 may update the attribute information on the document by editing the document or the attribute information on the document transmitted from the joint DMS 2. When the updated document is re-registered on the joint DMS 2, the in-house system 1 may overwrite the document prior to being updated in the joint DMS 2 with the document updated in the in-house system 1. The update process of updating a document managed in the joint DMS 2 with the document modified in the in-house system 1 is described below. In the update process performed by the user in the company B, the attribute information fp1 “A” of the document “File1.dfmt2” is updated with “G” and the attribute information fp3 “null” is updated with “H”.

FIG. 10 illustrates a display example on an update screen used when a document registered on the joint DMS 2 is updated. The user in the company B performs a predetermined operation to cause a browser to retrieve a web page from the joint DMS 2, thus causing the user terminal 12b to display the update screen. The user may select an update button after specifying a document file as an update target and a file name. The user terminal 12b transmits to the in-house DMS 11b an update request including an item specified on the update screen.

Upon receiving the update request from the user terminal 12b, the document management unit 111b in the in-house DMS 11b retrieve the document “File1.dfmt2” as an update request target from the document memory 112b, attaches the document “File1.dfmt2” to the update request and then transmits the resulting file to the joint DMS 2.

In response to the update request from the in-house system 1b, the contents of the process executed in the joint DMS 2 may be basically identical to the contents of the document registration process illustrated in FIG. 4.

In response to the update request from the in-house system 1b, the shared document management unit 21b in the tenant system 20b of the company B in the joint DMS 2 verifies the file format of the document attached to the update request. The file format of the document “File1” is dfmt2 and is thus different from the file format dfmt3 used in the joint DMS 2. The document management unit 111b instructs the file converter 22b to perform the file format conversion.

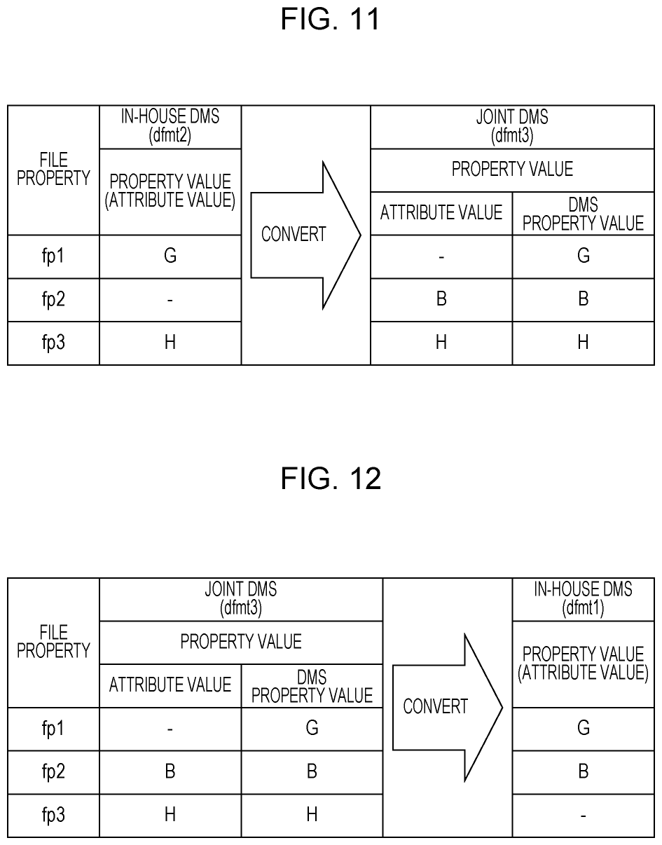

A format converter unit 221b in the file converter 22b converts the file format of the document “File1.dfmt2” from dfmt2 to dfmt3. The property converter unit 222b in the file converter 22b converts the attribute information on the document “File1.dfmt2” to the file format dfmt3. The conversion process of the attribute information is described with reference to FIG. 11.

As previously described with reference to FIG. 2, the document file in the file format dfmt2 includes the attribute information fp1 and fp3. FIG. 11 illustrates that the attribute values of the attribute information fp1 and fp3 are “G” and “H”, respectively. The file property fp2 does not correspond to the attribute information on the document file in the file format dfmt2 and is unable to include an attribute value. The symbol “-” indicates that the file property fp2 is unable to include an attribute value.

The document file in the file format dfmt3 subsequent to the conversion may include the file properties fp2 and fp3 as the attribute information but is unable to include the file property fp1. The property converter unit 222b includes, as the attribute information on the document file in the file format dfmt3 subsequent to the conversion, the attribute value “H” of the common attribute information fp3 out of the attribute information fp1 and fp3 of the document in the file format dfmt2. The document file in the file format dfmt3 is unable to include as the attribute information thereof the attribute value “G” of the attribute information fp1. The symbol “-” in FIG. 11 indicates that the document file in the file format dfmt3 is unable to include the attribute information fp1. The document in the file format dfmt3 may include as the attribute information the file property fp2 but the document file in the file format dfmt2 prior to the conversion does not include the file property fp2 as the attribute information. In accordance with the exemplary embodiment, as illustrated in FIG. 5, the DMS property value (attribute value in the case of the attribute information) of the additional information (or the attribute information) of the document “File1.dfmt3” prior to the conversion includes the attribute value “B” of the attribute information fp2 of the document “File1.dfmt3” prior to the conversion. The property converter unit 222b thus includes “B” read from the additional information (or the attribute information) of the document “File1.dfmt3” prior to the conversion as the attribute information fp2 of the document “File1.dfmt3” subsequent to the conversion. Specifically, in accordance with the exemplary embodiment, the attribute value of the attribute information (in this case, the attribute information fp2) of the document “File1.dfmt3” prior to the conversion is taken over without missing. In the process describe above, the additional information on the document prior to the conversion is referenced and this is different from the process of the registration.

The attribute value “G” of the attribute information fp1 that is not included in this setting remains missing. The property converter unit 222b updates the DMS property value of the document “File1.dfmt3” with the attribute value “G” of the attribute information fp1 that is not included as the attribute information. Similarly, the property converter unit 222b updates the DMS property value of the document “File1.dfmt3” with the attribute value “H” of the attribute information fp3 of the document “File1.dfmt2” (or with the attribute value “H” of the attribute information fp2 of the document “File1.dfmt3” subsequent to the conversion). The property converter unit 222b further updates the DMS property value of the document “File1.dfmt3” with the attribute value “B” of the attribute information fp2 of the document “File1.dfmt3” subsequent to the conversion.

If the property is converted, the access controller 23b updates the shared document memory 24a with the document “File1.dfmt3” that is format-converted with the updated additional information attached thereto. Specifically, the access controller 23b overwrites the document “File1.dfmt3” prior to the update with the updated document “File1.dfmt3”. It is also possible that the documents may be caused to coexist by managing versions of the documents.

The process in which the user in the company A retrieves the document registered on the joint DMS 2 by using the user terminal 12a is described below. The contents of the retrieval process are identical to those in the document retrieval process in FIG. 6.

The document to be retrieved may now be the document “File1.dfmt3”. The process in FIG. 6 is performed and the detailed description of the process is thus omitted as appropriate. As previously described, the property converter unit 222a converts the property subsequent to the format conversion of the document file. The file property to be converted is described with reference to FIG. 12.

The file property of the document “File1.dfmt3” prior to the conversion is identical to the file property in FIG. 11 prior to the conversion. As previously described with reference to FIG. 2, the document file in the file format dfmt3 includes the attribute information fp2 and fp3. On the other hand, the document file in the file format dfmt1 subsequent to the conversion may include the file properties fp1 and fp2 as the attribute information. The property converter unit 222a thus includes, as the attribute information on the document file in the file format dfmt1 subsequent to the conversion, the attribute value “B” of the common attribute information fp2 out of the attribute information fp2 and fp3 of the document in the file format dfmt3. Since the attribute information fp3 of the document in the file format dfmt3 is unable to be included as the attribute information on the document file in the file format dfmt1 subsequent to the conversion and is thus denoted by the symbol “-”. Although the document in the file format dfmt3 does not include as the attribute information the attribute information fp1 that the document in the file format dfmt1 may include, the additional information on the document “File1.dfmt3” includes the DMS property “G” as the attribute information. The property converter unit 222a references the additional information and includes the DMS property value “G” in the attribute information on the document “File1.dfmt1” in the file format dfmt1.

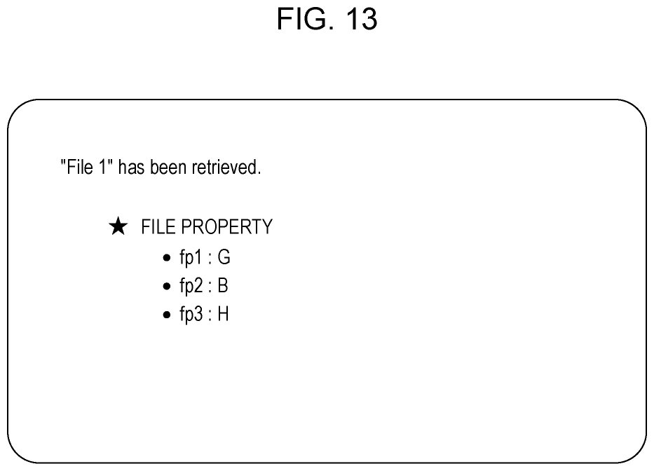

FIG. 13 illustrates a display example when the file property of the document retrieved from the joint DMS 2 and having a file name “File1” is displayed on the display screen of the user terminal 12a in accordance with the exemplary embodiment. As previously described, the in-house system 1a manages the documents in the file format dfmt1. The file properties fp1 “G” and fp2 “B” are read from the attribute information on the document “File1.dfmt1” and displayed on the screen. Although the file property fp3 is not included in the attribute information on the document “File1.dfmt1”, the document management unit 111a retrieves from the shared document management unit 21a the file property fp3 “H” not included in the attribute information on the document “File1.dfmt1” and provides to the user the file property fp3 “H” as the property value of the file property fp3 as illustrated in FIG. 13.

In accordance with the exemplary embodiment, the file property not included in the attribute information on the document managed in the in-house system 1 is also displayed on the screen to the user. As illustrated in FIG. 13, the file property of the File1 updated to be the latest by the user in the company B is thus provided to the user in the company A.

The in-house system 1c uses the file format dfmt3 that is identical to the file format used by the joint DMS 2. When documents are exchanged between the in-house system 1c and the joint DMS 2, the file format conversion and the property conversion are not performed.

As described above, the joint DMS 2 manages the documents in the file format dfmt3. In principle, however, a file format higher in versatility and compatibility is desirably used. A file format may be selected by referring to how many companies the file format is currently used by. As previously described, the file format conversion is performed when a file is exchanged between the joint DMS 2 and the in-house system 1 that uses the file format different from the file format used by the joint DMS 2. If the file format used by the in-house DMS 11 is identified, the format management unit 25 may determine the file format to be used in the joint DMS 2 by analyzing the file format of each in-house DMS 11. For example, one of the file formats of the in-house system 1 that is most widely used may be selected. The number of file format conversions may thus be reduced and the quality of the document file prior to and subsequent to the file format conversion may be maintained. From among the file formats used in each in-house DMS 11, a file format that may include a larger number of pieces of the attribute information within a document file may be determined to be the file format to be used in the joint DMS 2. In this way, the number of pieces of the attribute information that are converted to DMS property values and included and maintained in the additional information is thus reduced.

When documents are locally managed in the previous discussion, the company A uses the file format dfmt1, the company B uses the file format dfmt2, the company C uses the file format dfmt3, and the joint DMS 2 manages documents in the file format dfmt3. When the in-house DMS 11 serving as a registration (or update) requester or a retrieval requester is identified, the file converter 22 in the tenant system 20 may uniquely identify the file format of the documents used in the in-house DMS 11.

By analyzing the file format of a document added to the registration (or update) request or by enquiring of each of the in-house DMS 11a through in-house DMS 11c, the format management unit 25 may identify and manage the file formats of the documents used by the in-house DMS 11a through in-house DMS 11c. In this case, the file converter 22 references the file format managed by the format management unit 25. Specifically, in response to a prior notification from the format management unit 25 or by inquiring of the format management unit 25 when the file format conversion is performed, the file converter 22 may identify the file format of the document used by the in-house DMS 11 serving as a registration (update) requester or a retrieval requester.

The file properties used in the exemplary embodiment include a file property related to a document itself, such as time and date of creation of the document, a file property related to the whole document, and a file property that is set in response to a part of the document, such as the tag information. As described above, the file property is included as a DMS property value in the additional information. Depending on the type of file property, a combination of multiple values may be set in the additional information. For example, if the file property is the tag information, DMS property values, such as the color of a tag, the location of the tag, the person who has attached the tag, and/or the relationship with another tag, may be included in the additional information such that the DMS property values included in the additional information, if returned back into original attribute information, are in the original form thereof in the original attribute information.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a converter unit that, if a file in a second file format different from a first file format is received from another information processing apparatus, coverts the file to a file in the first file format; and
an adding unit that generates additional information including at least attribute information that is missing with the file converted by the converter unit out of attribution information included in the file in the second file format and adds the additional information to the file after being converted to the first file format.

2. The information processing apparatus according to claim 1, further comprising:
a memory that stores the file in the first file format; and
a registration controller that performs control to register on the memory, in response to a registration request of the file in the second file format, the file after being converted to the first file format and with the additional information added thereto by the adding unit.

3. The information processing apparatus according to claim 2, wherein if another information processing apparatus serving as a retrieval requester uses a file in the second file format different from the first file format, the converter unit converts the file in the first file format read from the memory into a file in the second file format in response to a retrieval request of the file registered on the memory by the registration controller, and
wherein the adding unit sets attribute information that is to be included in the file converted by the converter unit, in accordance with attribute information included in the file read from the memory and attribute information included in the additional information added to the file read from the memory.

4. The information processing apparatus according to claim 2, further comprising a determination unit that, if another information processing apparatus serving as a transmission source of the registration request has identified a file format to be used therewithin, determines a file format that is to be used as the first file format by analyzing the file format used in the transmission source.

5. The information processing apparatus according to claim 1, further comprising a management unit that manages a file format used in another information processing apparatus serving as a file receiver,
wherein by referencing the file format managed by the management unit, the converter unit identifies the file format of a file which is converted to a file in the first file format or the file format of a file to which the file in the first file format is converted.

6. A non-transitory computer readable medium storing a program causing a computer to execute a process for processing information, the process comprising:
if a file in a second file format different from a first file format is received from an information processing apparatus, converting the file to a file in the first file format; and
generating additional information including at least attribute information that is missing with the file converted in the converting out of attribution information included in the file in the second file format and adding the additional information to the file after being converted to the first file format.

7. An information processing apparatus comprising:
a converter unit that, if another information processing apparatus serving as a retrieval requester uses a file in a second file format different from a first file format, coverts a file in the first file format to the second file format in response to a file retrieval request;
a generating unit that generates additional information including attribute information that is missing if the file is converted by the converter unit, out of attribute information included in the file in the first file format; and
a display controller that performs control to display the attribute information included in the additional information together with attribute information included in the file in the second format when the attribute information included in the file in the second format is displayed on the retrieval requester.

8. The information processing apparatus according to claim 7, wherein the converter unit converts the file in the second file format to the file in the first file format if the file in the second file format is received from the retrieval requester, and
wherein the generating unit includes the attribute information included in the additional information in the attribute information on the file after being converted to the first file format by the converter unit.

9. The information processing apparatus according to claim 8, wherein the attribute information included in the file received from the retrieval requester has been modified by the retrieval requester.

10. The information processing apparatus according to claim 7, wherein the display controller performs control to display the attribute information included in the file in the first file format in accordance with display control information in which a setting as to whether to display the attribute information on a piece by piece basis is configured.

11. The information processing apparatus according to claim 7, further comprising a management unit that manages a file format used in another information processing apparatus serving as a file receiver,
wherein by referencing the file format managed by the management unit, the converter unit identifies the file format of a file which is converted to a file in the first file format or the file format of a file to which the file in the first file format is converted.

12. A non-transitory computer readable medium storing a program causing a computer to execute a process for processing information, the process comprising:
if an information processing apparatus serving as a retrieval requester uses a file in a second file format different from a first file format, converting a file in the first file format to the second file format in response to a file retrieval request;
generating additional information including attribute information that is missing in the converting, out of attribute information included in the file in the first file format; and
performing control to display the attribute information included in the additional information together with the attribute information included in the file in the second file format when the attribute information included in the file in the second file format is displayed on the retrieval requester.
